(19) United States
(12) Patent Application Publication
(10) Pub. No.: US 2018/0170603 A1
(43) Pub. Date: Jun. 21, 2018

(54) BASE SEAT DEVICE OF A SEALING MACHINE

(71) Applicant: Shu-Ling LIN, (US)

(72) Inventor: Chih-Hsin LIANG, Taichung City (TW)

(21) Appl. No.: 15/847,318

(22) Filed: Dec. 19, 2017

(30) Foreign Application Priority Data
Dec. 21, 2016 (TW) 105219424

(51) Int. Cl. B65B 65/00

(52) U.S. Cl. CPC B65B 65/00; F16K 1/36

(57) ABSTRACT

A base seat device includes an annular sealing seat and a drainage mechanism. The annular sealing seat has an annular base wall, an annular inner wall and an annular outer wall. The base wall cooperates with the inner wall and the outer wall to define an annular cleaning groove. The base wall is formed with a leakage recess, and has a through hole communicated with the cleaning groove. The drainage mechanism includes a drainage tube extending through the through hole, having a head portion that liquid-tightly seals the through hole, a tube body, and a drain opening disposed at the tube body. The drainage tube can be moved upwardly relative to the sealing seat to allow a liquid to flow out of the cleaning groove through the drain opening.

### CROSS-REFERENCE TO RELATED APPLICATION

This application claims priority of Taiwanese Patent Application No. 105219424, filed on Dec. 21, 2016.

### FIELD

The disclosure relates to a base seat device of a sealing machine, and more particularly to a base seat device of a sealing machine that includes a drainage mechanism.

### BACKGROUND

When operating a conventional sealing machine to seal the upper end opening of a cup with a film, the liquid contained in the cup usually leaks out during a sealing process. Therefore, a conventional sink is usually disposed for containing the leaked liquid. The conventional sink is usually required to be manually cleaned, and a cleaning process is thus complicated, thereby adversely affecting the working efficiency of the conventional sealing machine. In addition, when a cutting knife of the conventional sealing machine is required to be washed, a user needs to remove the cutting knife with a specific tool such that, a washing operation for the cutting knife is inconvenient.

Therefore, a conventional base seat device of a sealing machine disclosed in Chinese Patent No. 205396717 includes a knob disposed for controlling a drainage opening to be closed or opened. However, after the knob has been operated for a long time, a position-limiting block received in the knob is easy to be damaged, and thus a drainage passage cleaning operation is complicated, so that the operating effectiveness is reduced.

### SUMMARY

Therefore, the object of the disclosure is to provide a base seat device of a sealing machine that has simple structure, that is durable, and that is convenient to be cleaned.

According to the disclosure, the base seat device includes an annular sealing seat and a drainage mechanism. The annular sealing seat has an annular base wall, an annular inner wall extending upwardly from an inner periphery of the base wall, and an annular outer wall extending upwardly from an outer periphery of the base wall. The base wall cooperates with the inner wall and the outer wall to define an annular cleaning groove that is adapted for receiving a liquid. The base wall has a top surface facing the cleaning groove, and formed with a leakage recess, and a bottom surface located under the top surface. The leakage recess is defined by a recess bottom wall surface located below the top surface and above the bottom surface, and a recess side wall surface unit extending upwardly from the recess bottom wall surface to the top surface. The base wall further has a through hole extending downwardly from the recess bottom wall surface, and communicated with the cleaning groove. The drainage mechanism includes a drainage tube extending through the through hole and protruding downwardly from the base wall of the sealing seat, having a head portion that abuts against the recess bottom wall surface of the base wall, and that is disposed above the through hole, and that fully covers and liquid-tightly seals the through hole, a tube body that extends downwardly from the head portion, and at least one drain opening that is disposed at the tube body and that that is adapted for permitting the liquid to flow out of the cleaning groove therethrough when the drainage tube is moved upwardly relative to the sealing seat to allow for liquid communication between the at least one drain opening and the annular cleaning groove.

### BRIEF DESCRIPTION OF THE DRAWINGS

Other features and advantages of the disclosure will become apparent in the following detailed description of the embodiments with reference to the accompanying drawings, of which:

FIG. 1 is a schematic exploded perspective view of a first embodiment of a base seat device according to the disclosure;

FIG. 2 is a perspective view of the first embodiment;

FIG. 3 is a top view of the first embodiment;

FIG. 4 is a sectional view of the first embodiment;

FIG. 5 is a fragmentary sectional view taken along line V-V in FIG. 3;

FIG. 6 is a fragmentary sectional view taken along line VI-VI in FIG. 3, illustrating that a head portion of a drainage tube abuts against a base wall;

FIG. 7 is a view similar to FIG. 6, but illustrating that the head portion of the drainage tube is spaced apart from the base wall; and

FIG. 8 is a fragmentary sectional view of a second embodiment of the base seat device according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

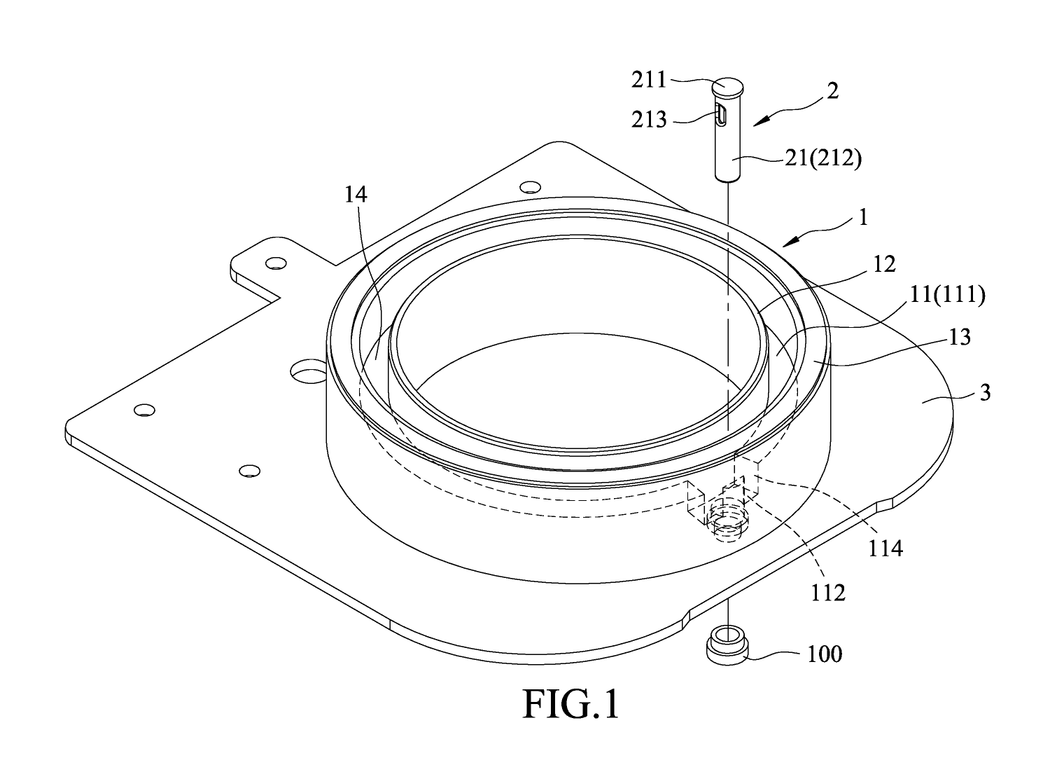

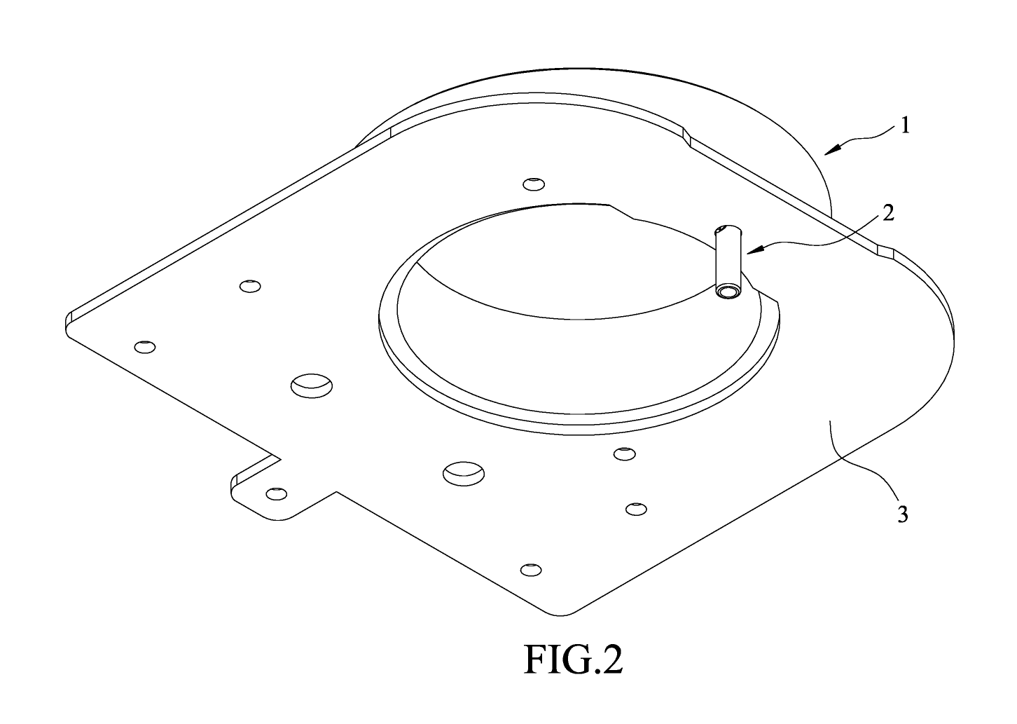

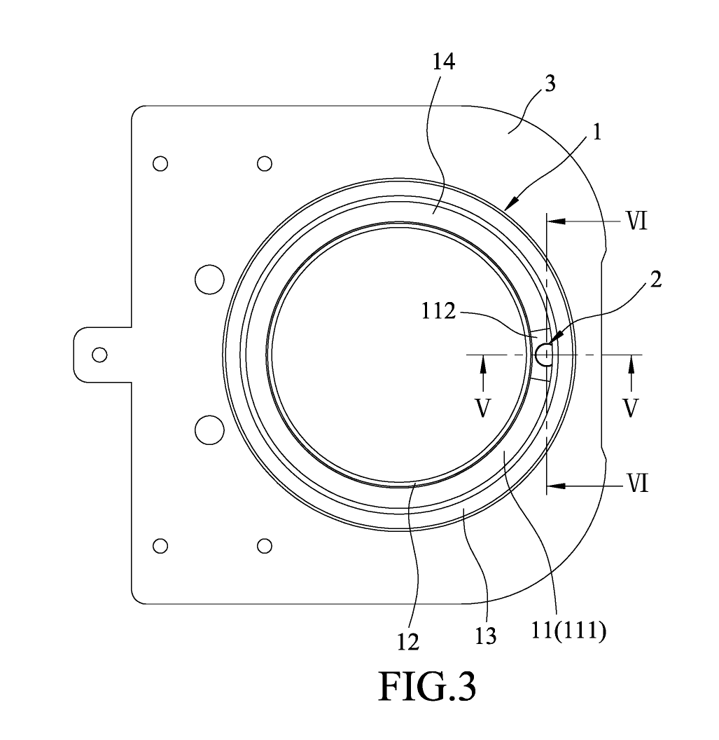

Referring to FIGS. 1 to 3, the first embodiment of a base seat device is adapted for use in a sealing machine (not shown), and includes an annular sealing seat 1, a drainage mechanism 2 and a positioning plate 3.

Referring to FIGS. 1, 3, 4 and 6, the sealing seat 1 has an annular base wall 11, an annular inner wall 12 extending upwardly from an inner periphery of the base wall 11, and an annular outer wall 13 extending upwardly from an outer periphery of the base wall 11. The base wall 11 cooperates with the inner wall 12 and the outer wall 13 to define an annular cleaning groove 14 that receives a liquid (not shown) for cleaning a cutting knife (not shown).

The base wall 11 has a top surface 111 facing the cleaning groove 14, and formed with a leakage recess 112, and a bottom surface located under the top surface 111. The leakage recess 112 is defined by a recess bottom wall surface 113 located below the top surface 111 and above the bottom surface, and a recess side wall surface unit 114 having three interconnected planar surface sections (only two are shown in FIG. 1) that respectively extend upwardly from three straight sides of the recess bottom wall surface 113 to the top surface 111 (i.e., the recess side wall surface unit 114 extends upwardly from the recess bottom wall surface 113). The base wall 11 further has a through hole 119 extending downwardly from the recess bottom wall surface 113, and communicated with the cleaning groove 14.

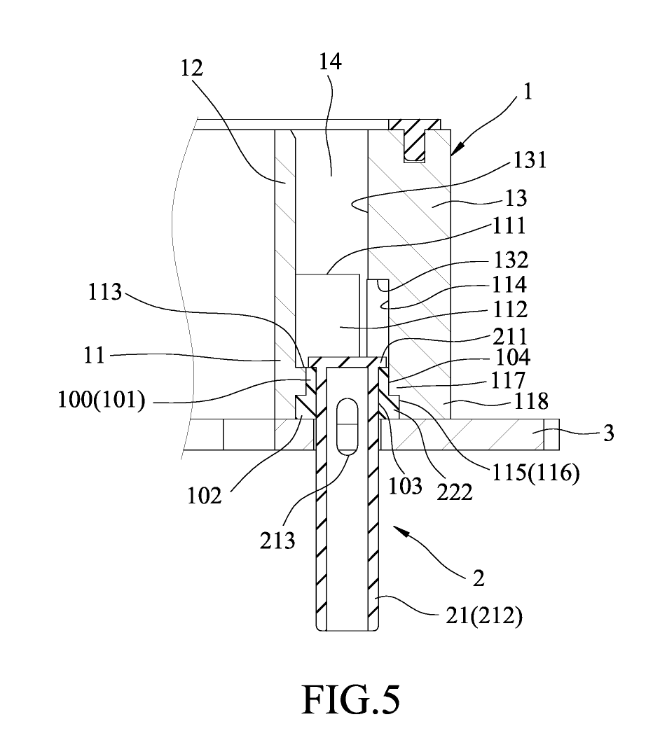

Referring to FIGS. 1, 5 and 6, in this embodiment, the base wall 11 further has an annular hole wall surface 116 defining a receiving hole 115 that is configured as a stepped hole, and a sealing member 100 received in the receiving hole 115. The annular hole wall surface 116 has a first section 117, and a second section 118 disposed under the first section 117, and having an inner diameter that is larger than that of the first section 117. The sealing member 100 is formed with the through hole 119.

The drainage mechanism 2 includes a drainage tube 21 extending through the through hole 119 and protruding downwardly from the base wall 11 of the sealing seat 1. In this embodiment, the sealing member 100 is disposed between the drainage tube 21 and the annular hole wall surface 116 of the base wall 11 so as to establish a liquid-tight seal therebetween. The drainage tube 21 has a head portion 211 abutting against the recess bottom wall surface 113 of the base wall 11, and disposed above and liquid-tightly sealing the through hole 119, a tube body 212 extending downwardly from the head portion 211, and at least one drain opening 213 disposed at the tube body 212. The head portion 211 is cylindrical, and has a diameter larger than that of the through hole 119. It should be noted that, in this embodiment, the head portion 211 of the drainage tube 21 abuts against a top surface of the sealing member 100 of the base wall 11, and the drainage tube 21 has two drain openings 213 disposed respectively and symmetrically at two opposite sides of the tube body 212. It should be noted that, the shape of the head portion 211 may be varied in other embodiments, and the numbers of the through hole 119, the drainage tube 21 and the drain openings 213 may be varied in other embodiments

In this embodiment, the sealing member 100 is sleeved onto the tube body 212 of the drainage tube 21, and has a body portion 101, and an abutment portion 102 extending radially and outwardly from a bottom end portion of an outer surface of the body portion 101. The body portion 101 has an inner surface 103 and an outer surface 104 respectively abutting against an outer surface of the tube portion 212 of the drainage tube 21 and the first section 117 of the annular hole wall surface 116 of the base wall 11. The abutment portion 102 abuts against a shoulder defined between the first and second sections 117, 118 of the annular hole wall surface 116 of the base wall 11.

The disposition of the sealing member 100 can increase the sealing effectiveness, and can prevent the liquid contained in the cleaning groove 14 from leaking from the through hole 119 through a space between the drainage tube 21 and the annular hole wall surface 116 of the base wall 11. In addition, since the abutment portion 102 of the sealing member 100 abuts against the shoulder defined between the first and second sections 117, 118 of the annular hole wall surface 116, the sealing effectiveness is further improved.

In this embodiment, the head portion 211 of the drainage tuber 21 abuts against the top surface of the sealing member 100 of the base wall 11, and the diameter of the head portion 211 is larger than the diameter of the through hole 119 such that, the through hole 119 can be sealed to prevent flow of the liquid contained in the cleaning groove 14 into the through hole 119. It should be noted that, in this embodiment, the outer wall 13 has an inner surrounding surface 131 facing the cleaning groove 14, and a recess top wall surface 132 (i.e., a surface defining the top end of the leakage recess 112) connected to the inner surrounding surface 131 and the recess side wall surface unit 114, and facing the drainage tube 21. With such disposition, a moving distance of the drainage tube 21 in a top-bottom direction is limited.

The positioning plate 3 is mounted to a bottom end portion of the sealing seat 1, and is disposed for the drainage tube 21 of the drainage mechanism 2 to extend therethrough.

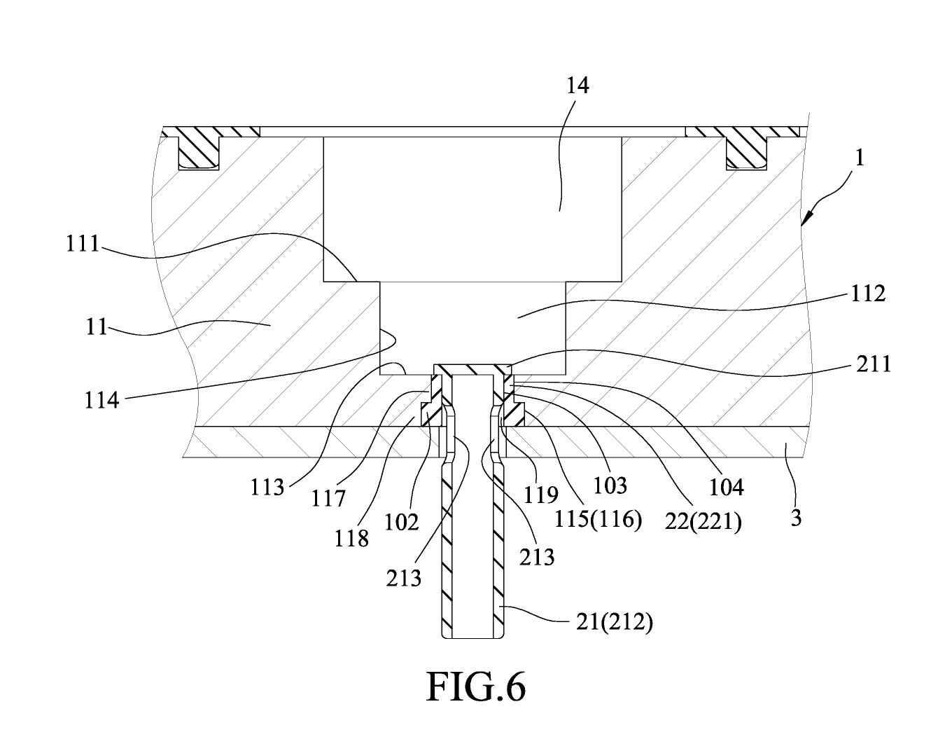

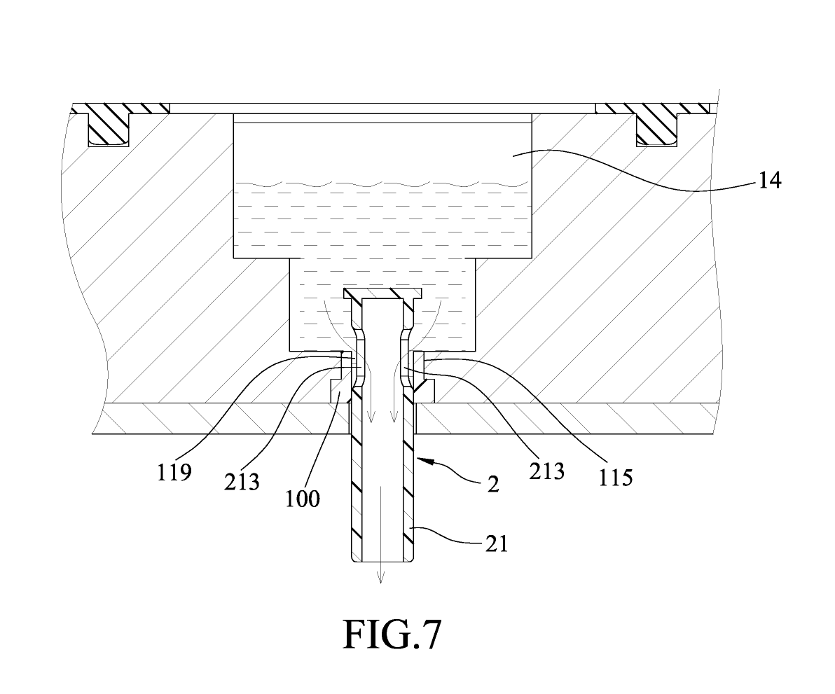

Referring to FIGS. 6 and 7, during operation, a user only needs to pull the drainage tube 21 upwardly to drain the liquid contained in the cleaning groove 14 out from the drain openings 213. When the user desires to carry out a knife washing operation, he or she only needs to release the drainage tube 21 to allow the head portion 211 to move downwardly by virtue of its weight to seal the through hole 119 to thereby keep the liquid inside the cleaning groove 14.

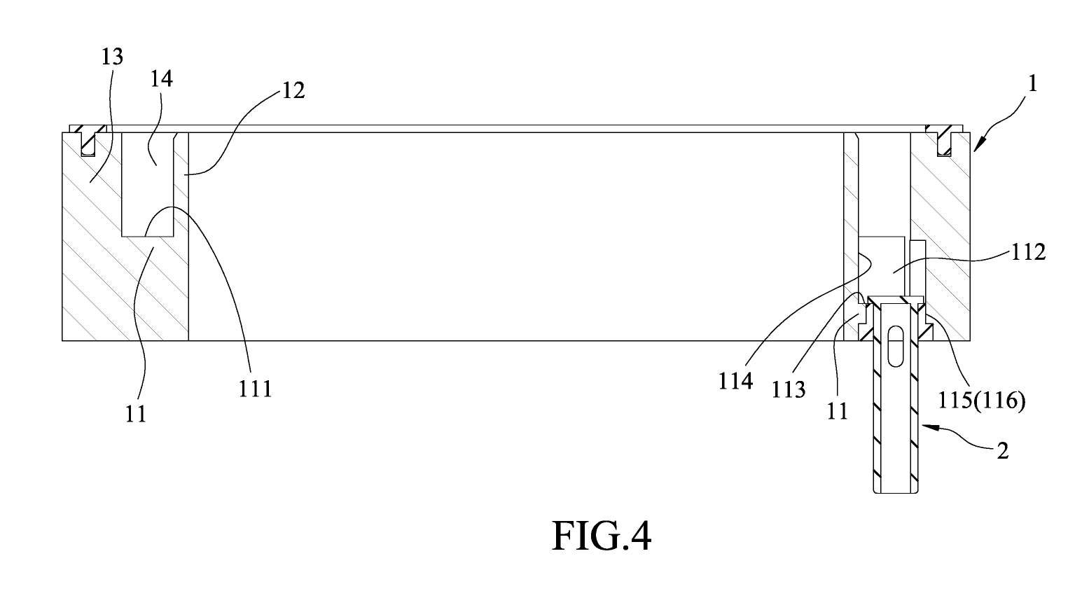

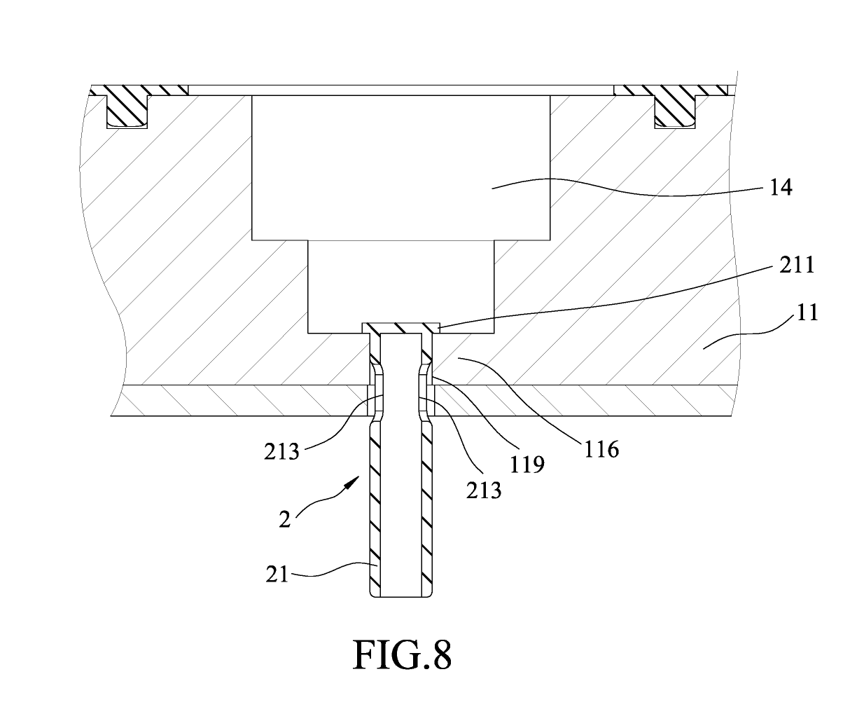

As shown in FIG. 8, the second embodiment has a structure similar to that of the first embodiment. The main differences between this embodiment and the previous embodiment reside in the configuration of the base wall 11. In this embodiment, the base wall 11 does not have the receiving hole 115 (see FIG. 4) and the sealing member 100 (see FIG. 1). Since the diameter of the head portion 211 of the drainage tube 21 is larger than the diameter of the through hole 119, the through hole 119 can still be fully covered and sealed, and the liquid can also be contained in the cleaning groove 14.

Therefore, the second embodiment has the same advantages as those of the first embodiment.

In conclusion, after a long term operation, the drainage tube 21 is difficult to be damaged. In addition, it is convenient to clean the drainage tube 21 since the user only needs to remove the drainage tube 21 from the remaining portion of the seat base device to clean the drainage tube 21 and the through hole 119. Therefore, the seat base device has knife washing function, can drain the liquid out quickly, is durable, and is easy to be cleaned.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A base seat device comprising:
an annular sealing seat having an annular base wall, an annular inner wall that extends upwardly from an inner periphery of said base wall, and an annular outer wall that extends upwardly from an outer periphery of said base wall, said base wall cooperating with said inner wall and said outer wall to define an annular cleaning groove that is adapted for receiving a liquid, said base wall having a top surface that faces said cleaning groove, and that is formed with a leakage recess, and a bottom surface that is located under said top surface, said leakage recess being defined by a recess bottom wall surface that is located below said top surface and above said bottom surface, and a recess side wall surface unit that extends upwardly from said recess bottom wall surface to said top surface, saidbase wall further having a through hole that extends downwardly from said recess bottom wall surface, and that is communicated with said cleaning groove; and
a drainage mechanism including a drainage tube that extends through said through hole, protrudes downwardly from said base wall of said sealing seat, that has a head portion abutting against said recess bottom wall surface of said base wall, and disposed above and fully covering said through hole, a tube body extending downwardly from said head portion, and at least one drain opening disposed at said tube body, and adapted for permitting the liquid to flow out of said cleaning groove therethrough when said drainage tube is moved upwardly relative to said sealing seat to allow for liquid communication between said at least one drain opening and said cleaning groove.

2. The base seat device as claimed in claim 1, wherein said drainage tube has two said drain openings disposed respectively and symmetrically at two opposite sides of said tube body.

3. The base seat device as claimed in claim 2, wherein said head portion is cylindrical, and has a diameter larger than that of said through hole.

4. The base seat device as claimed in claim 3, wherein:
said base wall further has an annular hole wall surface defining a receiving hole, and a sealing member that is formed with said through hole, that is received in said receiving hole, that is disposed between said drainage tube and said annular hole wall surface of said base wall so as to establish a liquid-tight seal therebetween, and that has a body portion; and
said body portion has an inner surface and an outer surface respectively abutting against an outer surface of said tube portion of said drainage tube and said annular hole wall surface of said base wall.

5. The base seat device as claimed in claim 4, wherein the diameter of said head portion is larger than an inner diameter of said body portion of said sealing member.

6. The base seat device as claimed in claim 5, wherein:
said annular hole wall surface of said base wall has a first section, and a second section disposed under said first section, and having an inner diameter that is larger than that of said first section;
said receiving hole is configured as a stepped hole, said sealing member further having an abutment portion that extends radially and outwardly from a bottom end portion of an outer surface of said body portion; and
said abutment portion abuts against a shoulder defined between said first and second sections of said annular hole wall surface of said base wall.

7. The base seat device as claimed in claim 6, further comprising a positioning plate mounted to a bottom end portion of said sealing seat, and disposed for said drainage mechanism to extend therethrough.
